(19) United States
(12) Patent Application Publication
(10) Pub. No.: US 2007/0084310 A1
(43) Pub. Date: Apr. 19, 2007

(54) AIR RATCHET TOOL WITH ROTATABLE HEAD

(75) Inventor: Shigeki Kobayashi, Nagano (JP)

Correspondence Address: SENNIGER POWERS, ONE METROPOLITAN SQUARE, 16TH FLOOR, ST LOUIS, MO, 63102, US

(73) Assignee: SP Air Kabushiki Kaisha, Akabane-Nishi Kita Ku (JP)

(21) Appl. No.: 11/279,180

(22) Filed: Apr. 10, 2006

Related U.S. Application Data
(60) Provisional application No. 60/727,074, filed on Oct. 14, 2005.

(51) Int. Cl. B25B 17/00; B25B 13/46

(52) U.S. Cl. 81/57.39

(57) ABSTRACT

A ratchet tool including a housing having a longitudinal axis, and a head having a ratchet mechanism with an output member capable of powered rotation. A motor is disposed in the housing for rotating the output member. A coupling attaches the head to the housing and is adapted to permit rotation of the head relative to the housing about the longitudinal axis of the housing. Thus, the head can be positioned at different selected angles relative to the housing.

This application claims priority to U.S. Provisional Application No. 60/727,074 filed Oct. 14, 2005, the entirety of which is herein incorporated by reference.

### BACKGROUND OF THE INVENTION

The present invention relates generally to wrenches, and more specifically to a ratchet tool having a rotatable head.

Powered ratchets, such as pneumatic ratchets, rotate an output member with a socket for turning a fastener element such as a bolt or a nut. These ratchets are useful in automotive repair and industrial applications. Pneumatic ratchets have a cylindrical housing designed for being held in a user's hand such that the user's fingers engage a trigger lever pivotally secured at a lower portion of the housing. In this way, the user can easily operate the ratchet (i.e., depress the trigger lever) by squeezing the trigger lever with her fingers.

The trigger lever is typically located on the same side of the ratchet as the output member. So, to maneuver the ratchet so that the socket on the output member engages a nut or bolt, the user has to adjust her wrist or arm or entire body to properly position the ratchet tool in engagement with the nut or bolt. However, in some situations, such as when the user is trying to tighten a nut or bolt that is hard to reach and/or is partially obstructed by other components or structures, there may not be enough space or room to adjust her wrist or arm or body to engage the nut or bolt with the ratchet. Thus, the user may have to change his or her grip on the tool, such as by improperly placing the palm of her hand over the trigger instead of her fingers. Changing the grip in this manner, however, makes it more difficult to both control the ratchet and squeeze the trigger lever.

### SUMMARY OF THE INVENTION

In one aspect, a ratchet tool generally comprises a housing having a longitudinal axis and a head including a ratchet mechanism with an output member capable of powered rotation. A motor disposed in the housing is operatively connected to the ratchet mechanism for rotating the output member. A coupling for attaching the head to the housing is adapted to permit rotation of the head relative to the housing about the longitudinal axis of the housing.

In another aspect, a pneumatic ratchet tool comprises a housing having a longitudinal axis and a head including a ratchet mechanism with an output member capable of powered rotation. An air motor disposed in the housing is operatively connected to the ratchet mechanism for rotating the output member. An air inlet is adapted to be coupled with a source of pressurized air for powering the air motor. A coupling for attaching the head to the housing is adapted to permit rotation of the head relative to the housing about the longitudinal axis of the housing.

Other objects and features will be in part apparent and in part pointed out hereinafter.

### BRIEF DESCRIPTION OF THE DRAWINGS

FIG. 1 is a perspective of a ratchet tool having a head in a first position with respect to a housing;

FIG. 2 is a perspective of an upper portion of the ratchet tool of FIG. 1 with parts broken away to show the head in a locked position with respect to the housing;

FIG. 3 is a view similar to the view of FIG. 2 but showing the head in an unlocked position with respect to the housing;

FIG. 4 is an exploded perspective of the ratchet tool of FIG. 1;

FIG. 5 is a perspective of the ratchet tool showing the head rotated to a second position with respect to the housing.

FIG. 6 is a perspective of a ratchet tool of another embodiment;

FIG. 7 is an exploded perspective of the ratchet tool of FIG. 6;

FIG. 8 is a perspective of an upper portion of the ratchet tool of FIG. 6 with parts broken away and the housing removed to show the head in a locked position;

FIG. 9 is an enlarged fragmentary view of a locking mechanism shown in FIG. 8;

FIG. 9A is a cross-section of a sleeve of the ratchet tool;

FIG. 10 is a view similar to the view of FIG. 8 but showing the head in an unlocked position; and

FIG. 11 is a perspective of the ratchet tool showing the head rotated to a second position with respect to the housing.

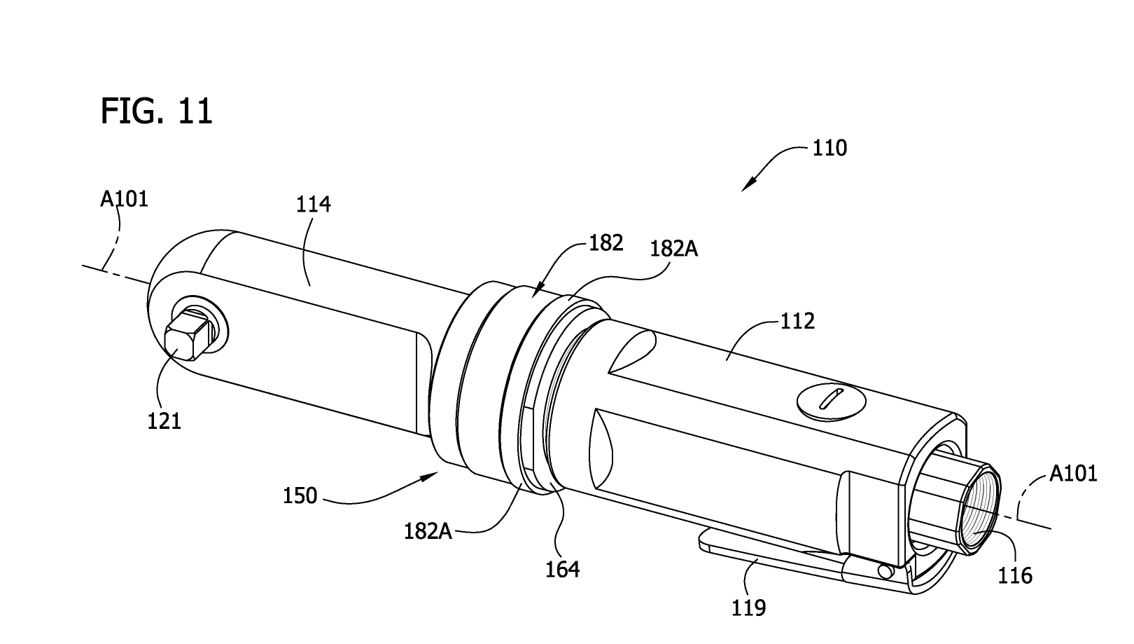

Corresponding reference characters indicate corresponding parts throughout the drawings.

### DETAILED DESCRIPTION OF THE INVENTION

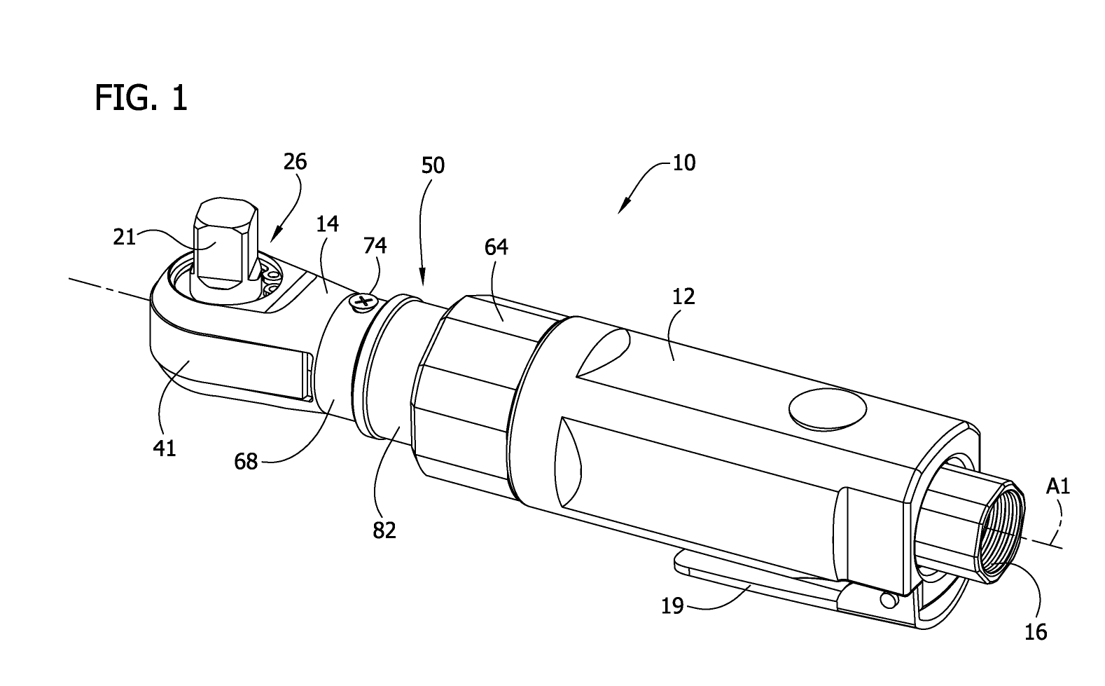

Referring now to the drawings and particularly to FIG. 1, a pneumatic drive ratchet tool constructed according to the teachings of the present invention is generally indicated at reference numeral 10. The ratchet tool 10 includes an elongate housing 12 having a longitudinal axis Al. A head 14 of the tool 10 extends axially from one end of the housing 12, and an air inlet 16 extends from an opposite end for connection to a source of pressurized air (not shown). It is understood that when referring to relative positions and directions of movement of the various components of the tool, it is assumed, for purposes of convenience which are in no way limiting, that the tool is orientated in a vertical plane whereby the head 14 is located above the housing 12. A trigger 19 for controlling the introduction of pressurized air into the housing 12 is adjacent the air inlet 16. The air drives an air motor (not shown) in the housing 12 for driving an output member 21 of the tool 10. It will be understood that other motors, such as electric motors, may be used within the scope of the present invention.

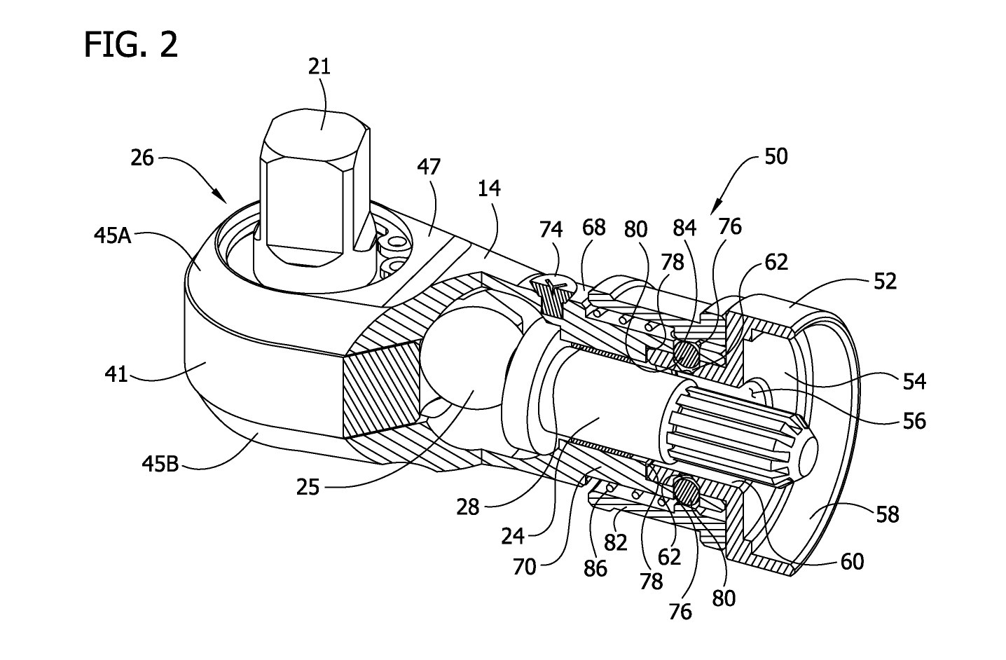

Referring to FIG. 2, in one example, the air motor is coupled to a transmission which includes a shaft 24 having an eccentric 25 that operatively connects the air motor to a ratchet mechanism, generally indicated at 26, for converting rotary motion of the shaft caused by the air motor into oscillating motion of the ratchet mechanism. A bearing 28 inserted in the tool 10 allows the shaft 24 to rotate within the tool. An oscillating member 41 of the ratchet mechanism 26 is located between arms 45A and 45B of a yoke 47 of the head 14. The oscillating member 41 generally aligns with openings in the arms 45A, 45B of the yoke 47 for receiving components of the ratchet mechanism 26 (some of which are not shown). The components of the ratchet tool 10 are constructed of metal, and more specifically steel, although it is contemplated that the components may be constructed of other materials, such as plastic.

In operation, rotation of the eccentric 25 of the shaft 24 causes the oscillating member 41 to rock back and forth, which results in rotation of the output member 21 in a clockwise direction. After the shaft 24 rotates one half rotation (i.e., rotates 180°), the oscillating member 41 reverses rotation and rotates counterclockwise. The oscillating member 41 disengages the output member 21 thereby allowing the oscillating member to be moved without moving the output member 21. Once the shaft 24 rotates another one half rotation, the oscillating member 41 re-engages the output member 21 to further turn the output member 21 in a clockwise direction. The process repeats until the trigger 19 is disengaged. The ratchet tool 10 further includes a reversing switch (not shown) for reversing the rotational direction of the output member 21. Operation of the tool 10 is similar for turning the output member 21 in a counterclockwise direction as it is for turning the output member in a clockwise direction.

The ratchet mechanism 26 and its operation are essentially conventional in the illustrated embodiment. It is understood that the construction of the ratchet tool 10, more particularly the construction of the ratchet mechanism 26, for producing rotational movement of the output member 21 may differ from the illustrated embodiment without departing from the scope of this invention. For example, the ratchet mechanism may be similar to the mechanism disclosed in U.S. Pat. Nos. 6,578,643 and 6,860,174, both of which are herein incorporated by reference. In other words, other types of ratchet mechanisms are within the scope of this invention.

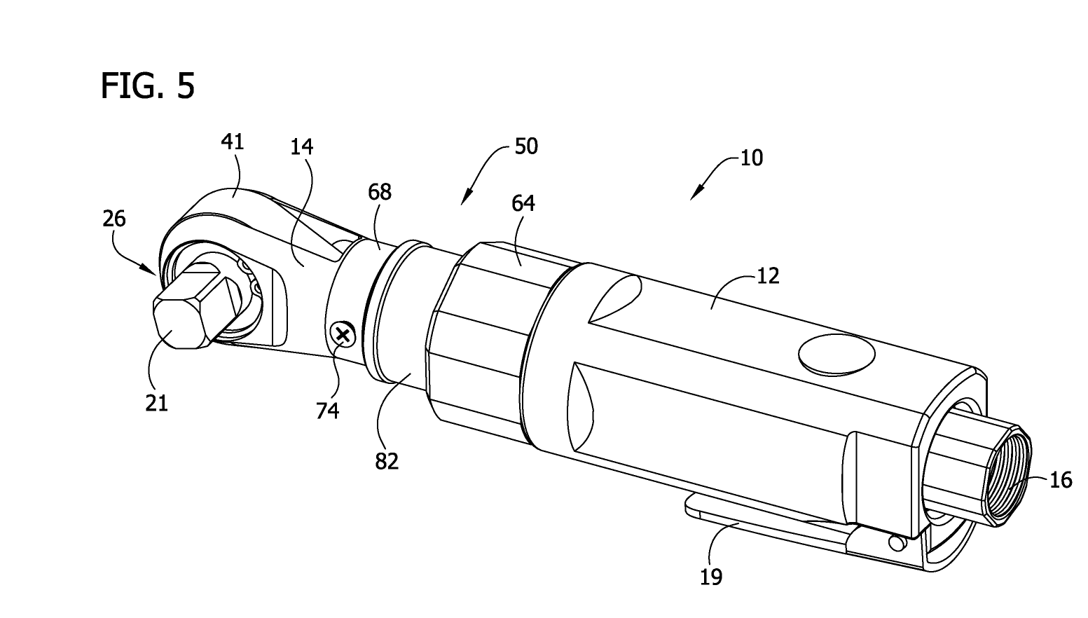

Referring now to FIGS. 1-5, the head 14 of the ratchet tool 10 can be rotated 360° with respect to the tool housing 12 about the longitudinal axis A1 of the housing. For example, the head 14, as illustrated in FIG. 1, can be in one orientation with respect to the housing 12 or it can be rotated to another orientation with respect to the housing, as shown in FIG. 5. Thus, the location of the output member 21 can be selectively changed with respect to the trigger 19. A locking mechanism, generally indicated at 50, releasably locks the head 14 in any one of four positions to prevent further rotation of the head until such time as the user unlocks the locking mechanism to once again allow rotation the head. The number of selected positions may be other than described without departing from the scope of the present invention. This mechanism prevents the head 14 from further rotating when the user is operating the tool 10. Accordingly, the tool 10 of the present invention is more versatile than conventional air ratchet wrenches because the user does not have to change his or her grip on the housing 12 to change the orientation of the output member 21. Thus, the user does not have to circumvent proper grip of the tool when maneuvering the tool to engage a “hard-to-reach” fastener.

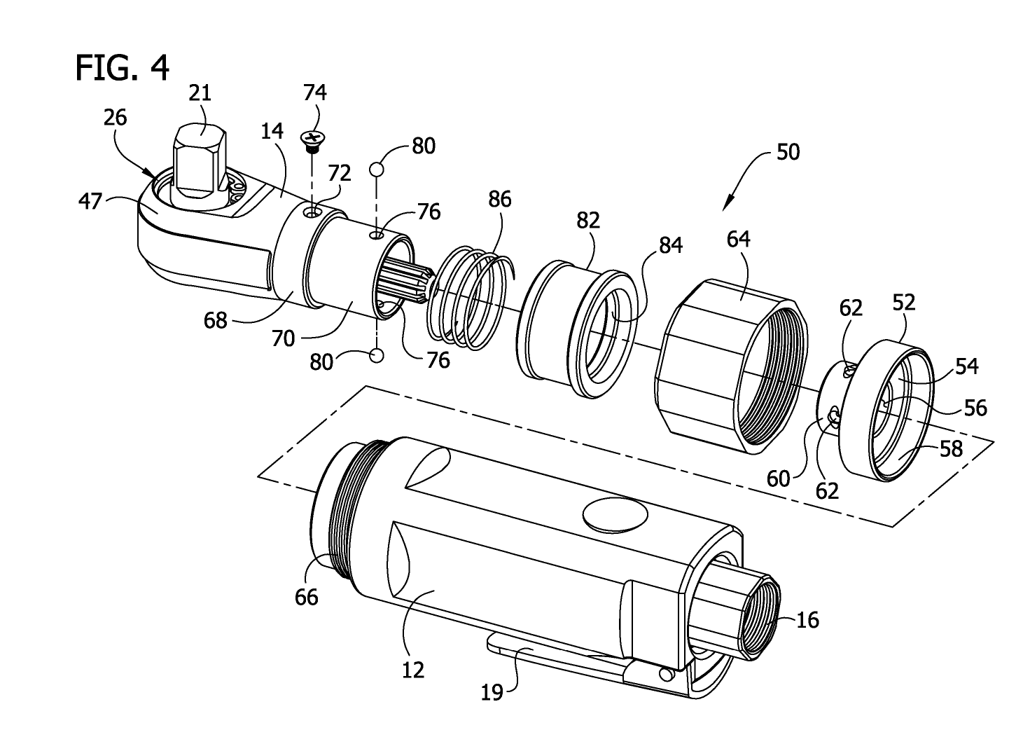

With reference now to FIG. 4, a coupling 52 joins the rotatable head 14 to the housing 12. The coupling 52 comprises an annular shoulder 54 having an outer edge, and an inner edge defining a hole 56 therein. A tubular skirt 58 extends outwardly from the shoulder 54 adjacent the outer edge margin of the shoulder to define a socket for receiving and connecting to a portion of the housing 12. A tubular body 60 is attached to the annular shoulder 54 on the opposite side of the shoulder from the skirt 58, and extends outwardly from the shoulder adjacent the inner edge. The tubular body 60 has four recesses 62 evenly spaced about its circumference (only three of the recesses being illustrated in the drawings.) A threaded cap 64 mates with threads 66 on the housing 12 for capturing the coupling 52 on the housing.

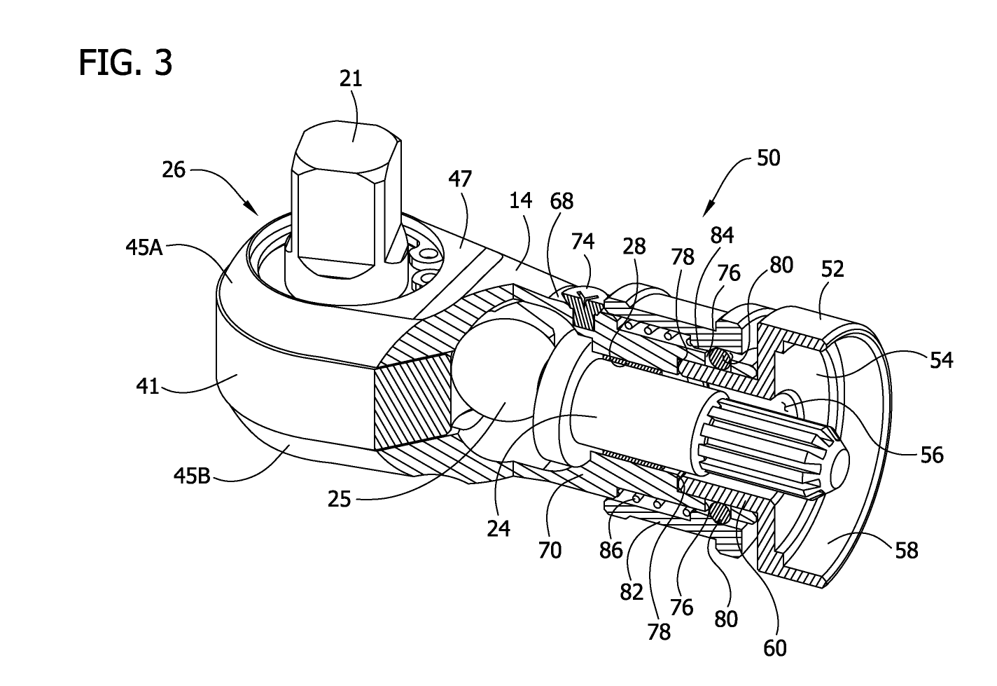

As shown in FIG. 4, the head 14 includes a collar 68 and tubular segment 70 extending outwardly from the collar. The collar 68 includes an aperture 72 for receiving a screw 74. The tubular segment 70 has two opposed openings 76. The tubular segment 70 receives the tubular body 60 of the coupling 52. An internal, annular shoulder 78 of the tubular segment 70 (FIGS. 2 and 3) acts as a stop to locate the tubular body 60 when the coupling is received in the tubular segment so that two of the recesses 62 in the tubular body align longitudinally with the two openings 76 in the tubular segment (FIG. 2). A ball 80 (broadly, a catch) is located in each of the openings 76 in the tubular segment 70 and extends through the openings 76 in the tubular segment and into the recesses 62 in the smaller tubular body 60.

The locking mechanism 50 includes a sleeve 82 (broadly, a locking member) that extends around the tubular segment 70 of the head 14 and includes an internal ridge 84 (broadly, an internal retainer) spaced inwardly from each of end of the sleeve. The ridge 84 is sized and positioned on the sleeve 82 to hold each of the balls 80 so that it projects radially inwardly from the hole 76 and into the recess 62. The sleeve 82 can be selectively moved from a locked position in which the ridge 84 of the sleeve engages and secures the balls 80 in the recesses 62 to thereby prevent rotation of the head 14 with respect to the housing 12 (FIG. 2) to an unlocked position in which the ridge is spaced from the balls (FIG. 3). To move the sleeve 82 to the unlocked position, the sleeve is slid axially along the longitudinal axis A1 of the housing 12 upward away from the housing. The screw 74 acts as a stop to prevent the sleeve 82 from being moved too far. In the unlocked position, the head 14 can be rotated with respect to the housing 12. As the head 14 is rotated, the ball 80 is pushed out of the recess 62 and around the circumference of the small tubular body 60 of the coupling 52 by the tubular segment 70 of the head 14. The sleeve 82 continues to retain the balls 80 in the openings 76. Once the head 14 is moved to the desired location, the sleeve 82 is slid downward back to the locked position causing the ridge 84 of the sleeve to secure the balls 80 in both the openings 76 in the tubular segment 70 and the recesses 62 in the smaller tubular body 60 of the coupling 52 to thereby prevent rotation of the head. Each of the recesses 62 in the smaller tubular body 60 corresponds to a position in which the head 14 can be rotated. In the illustrated embodiment, the head 14 can he rotated to four different positions. A spring 86 biases the sleeve 82 toward the locked position. Other ways of locking and releasing the head 14 may be used within the scope of the present invention.

As is now apparent from the above description, the head 14 including the output member 21 can be selectively moved to various positions. In the illustrated configuration, the output member 21 can be moved between four different positions, each spaced apart by about 90°. Each position of the output member 21 corresponds to one of the recesses 62 in the smaller tubular body 60 of the coupling 52. It is understood however that the output member 21 can have more or fewer positions by adding or subtracting recesses 62 in the smaller tubular body 60. For example, if the smaller tubular body had eight openings then the output member could be moved between eight different positions. On the other hand, if the smaller tubular body only had two openings then the output member could only be moved between two different positions.

When the head 14 of the tool 10 is rotated, the entire drive mechanism (i.e., the shaft and movable components of the air motor) is rotated within the housing 12. It is understood however that the drive mechanism may include a coupling which limits the amount of rotation in the drive mechanism (e.g., prevents the air motor from rotating when the head is being rotated).

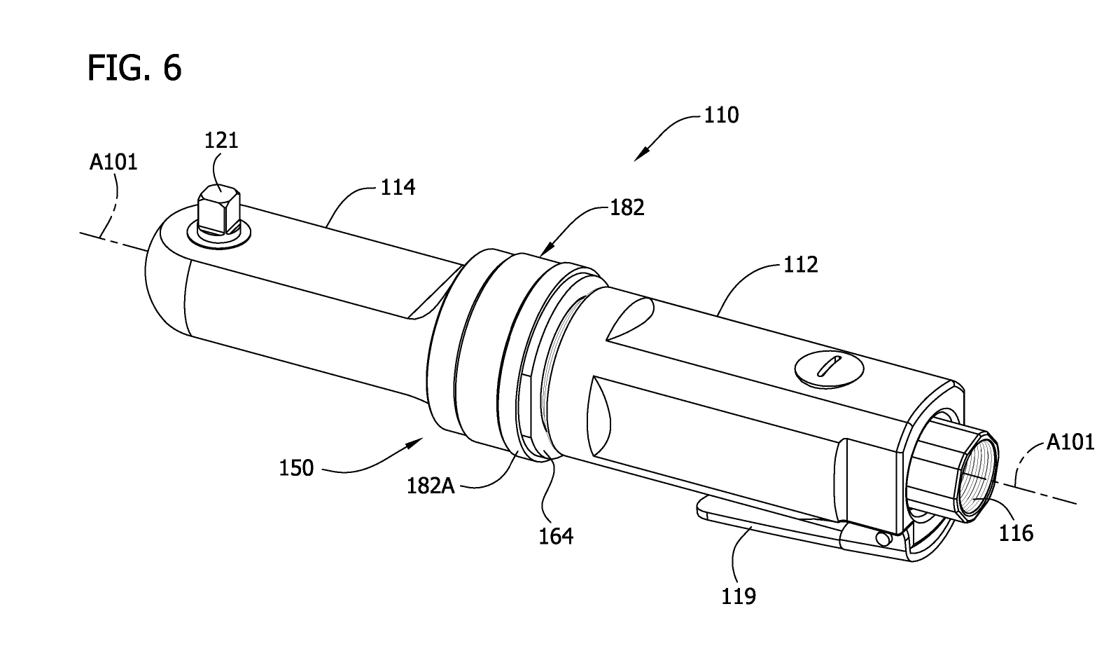

Referring to FIG. 6-10, another embodiment of a pneumatic drive ratchet tool is generally indicated by reference numeral 110. The ratchet tool 110 is generally of the type taught in U.S. Pat. No. 6,578,643, which has been incorporated by reference. The primary difference between this embodiment and the previous embodiment besides the type of ratchet is the operation of a locking mechanism, generally indicated at 150. More specifically, the operation of the locking mechanism 150 is reversed, whereby moving a sleeve 182 downward, instead of upward, allows a head 110 to be rotated.

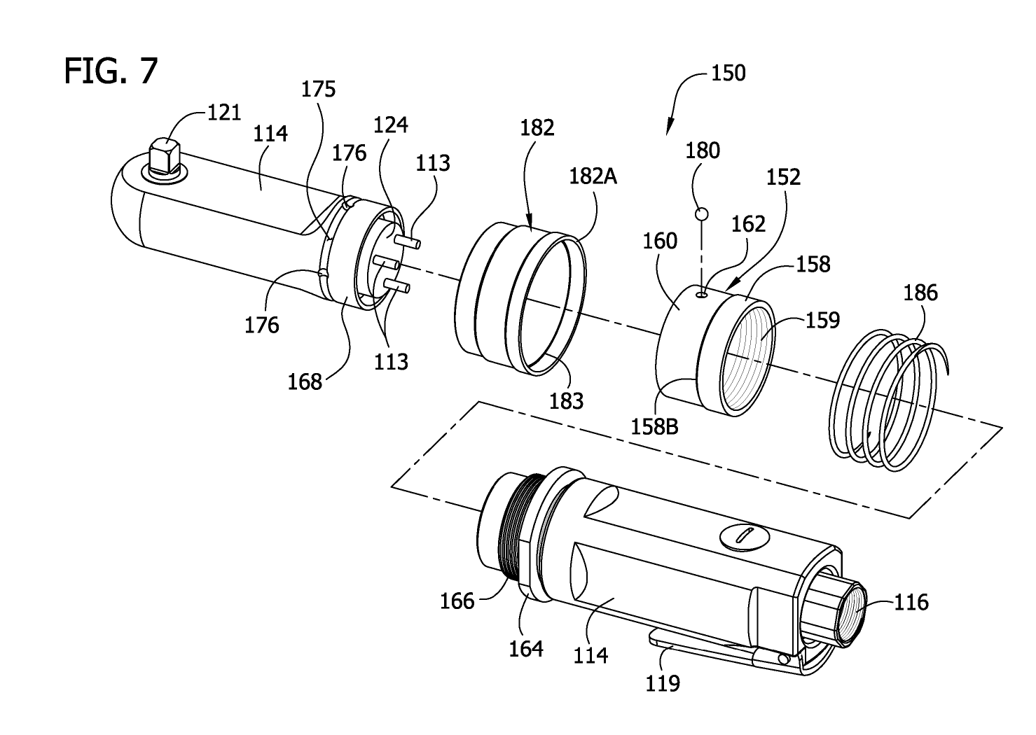

Referring to FIG. 7, the ratchet tool 110 includes an elongate housing 112 having a longitudinal axis A101. The head 114 of the tool 110 is elongate and extends axially from one end of the housing. An air inlet 116 extends from an opposite end for connection to a source of pressurized air (not shown). An air motor (not shown) within the housing 112 is connected to a transmission that includes three orbital gears (not shown) coupled to three corresponding pegs 113 extending axially from one end of a shaft 124 located within the head 114. Rotation of the orbital gears imparts rotation of the shaft 124. An eccentric (not shown) similar to the eccentric 25 of the previous embodiment extends from an opposite end of the shaft and is received in an opening of a rocker (not shown). A pair of pawls (not shown) extends from the rocker and engages a ratchet wheel that includes an output member 121. Rotation of the shaft 124 imparts back and forth movement of the rocker thereby oscillating the pawls and imparting rotational movement of the ratchet wheel and the output member 121.

The head 114 of the ratchet tool 100 can be rotated 360° with respect to the tool housing 112 about the longitudinal axis A101 of the housing. Thus, the location of the output member 121 can be selectively changed with respect to a trigger 119. The locking mechanism 150 locks the head 114 in a selected position to prevent further rotation of the head until such time as the user unlocks the head to once again allow rotation of the head. This mechanism 150 prevents the head 114 from further rotating when the user is operating the tool 110.

Referring to FIG. 7, a coupling, generally indicated at 152, joins the rotatable head 114 to the housing 112. The coupling 152 comprises a first tubular body 158 having outer and inner peripheries and threads 159 formed along its inner periphery for connection to a threaded component 166 of the housing 112. A smaller second tubular body 160 of the coupling 152 extends axially outward from the larger tubular body 158. The outer periphery of the larger tubular body 158 includes an outer edge 158B at the intersection of the smaller tubular body 160. The smaller tubular body 160 has a pair of opposing openings 162 (only one of the openings is shown in the drawings). A ball 180 (broadly, a catch) is received in each of the openings 162.

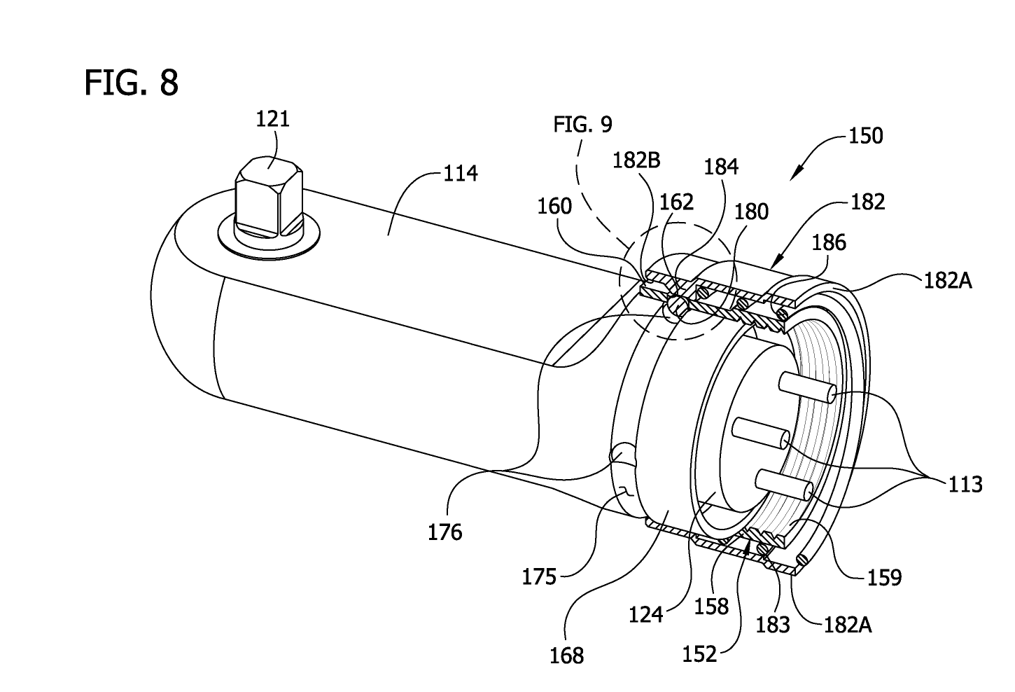

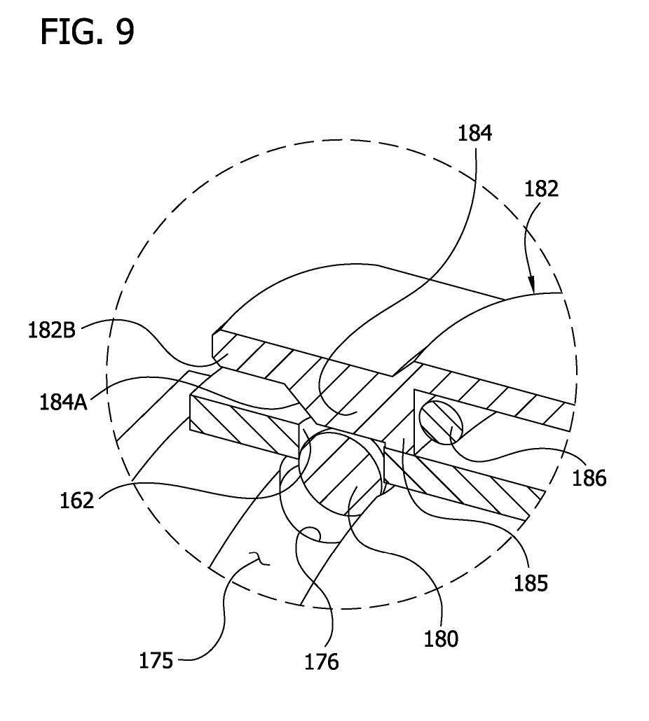

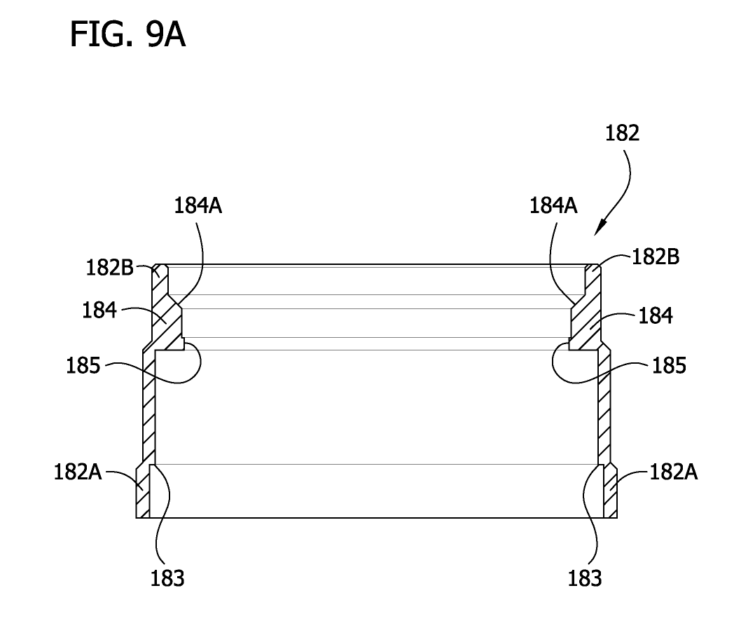

Referring to FIGS. 7, 8 and 10, a lower tubular portion 168 of the head 114 of the tool 110 surrounding the lower portion of the shaft 124 defines a circumferential channel 175 with four recesses 176 evenly spaced within the channel (only two recesses are shown in the drawings). It is understood that the head 114 may have more or less than four recesses 176, depending on the desired number of selective positions of the head 114. Referring to FIGS. 8 and 9, the coupling 152 is sized and shaped to receive the lower tubular portion 168 of the head 114 so that each opening 162 in the coupling can align with selected recess 176 of the head for receiving a ball 180 to prevent rotation of the head with respect to the housing 112 (only one ball is shown in the drawings). A threaded ring 164 (FIGS. 6 and 7) secured to the threaded component 166 of the housing 112 contacts a lower edge of the coupling 152 to properly locate the coupling longitudinally so that the openings 162 and the recess 176 are aligned. When the head 114 is received in the coupling 152, the pegs 113 couple with the respective orbital gears.

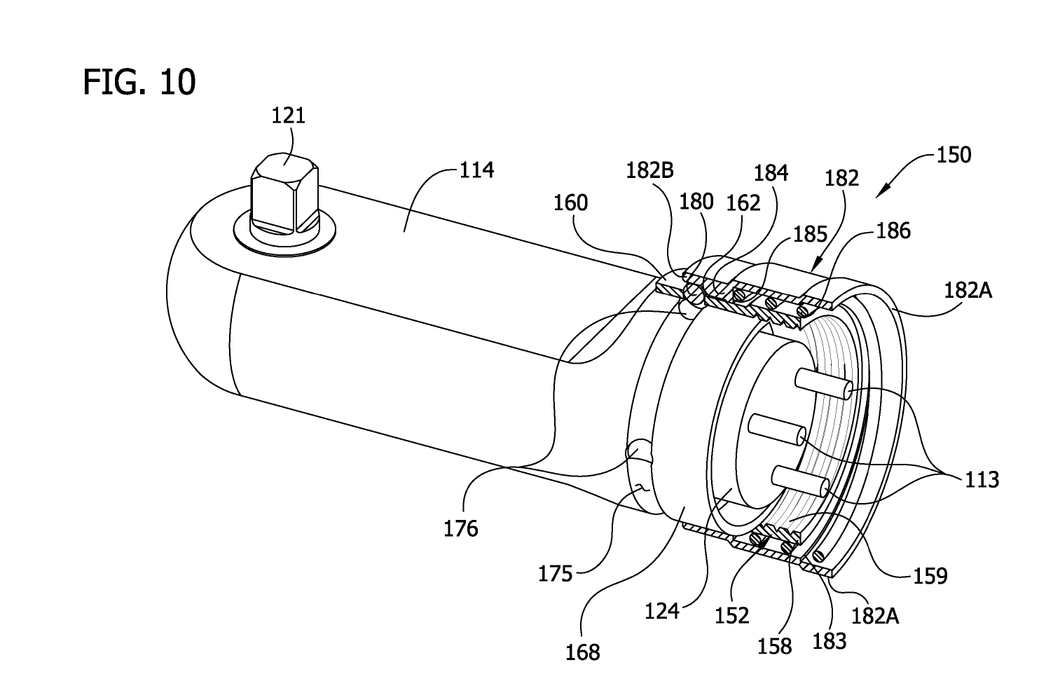

The locking mechanism 150 includes a sleeve (broadly, a locking member), generally indicated at 182, extending around the coupling member 152. The sleeve 182 includes an internal annular ridge 184 (broadly, a retainer) disposed between ends of the sleeve. The ridge 184 is sized and positioned on the sleeve 182 to secure each of the balls 180 in the respective aligned opening 162 of the coupling 152 and recess 176 of the head 114. The sleeve 182 can be selectively moved from a locked position, in which the ridge 184 of the sleeve engages and secures the balls 180 in the respective openings 162 and recesses 176 to thereby prevent rotation of the head 114 with respect to the housing 112 (FIGS. 8 and 9), to an unlocked position in which the ridge disengages the balls (FIG. 10) and allows the balls to move out of the recesses. A spring 186 biases the sleeve 182 toward the locked position. The spring 186 extends between and engages the threaded ring 164 and the annular ridge 184.

To move the sleeve 182 to the unlocked position, the sleeve is slid axially along the longitudinal axis A101 of the housing 112 from the position shown in FIG. 8 toward the housing so that the annular ridge 184 is located below the balls 180 as shown in FIG. 10. A lower portion 182A of the sleeve 182 is sized and shaped to slide over the threaded ring 164 (FIGS. 9A and 10). An internal annular shoulder 183 disposed above the lower portion 182A contacts the ring 164 to limit longitudinal movement of the sleeve. In the unlocked position, the head 114 can be rotated with respect to the housing 112. As the head 114 is rotated, each ball 180 is pushed out of the respective recess 176 and moved in the channel 175 around the circumference of lower tubular portion 168 of the head 114 within the openings 162. An upper portion 182B (FIGS. 9A and 10) of the sleeve 182 above the annular ridge 184 is disposed over the balls 180 when the sleeve is unlocked. The upper portion 182B prevents the balls 180 from falling out of the openings 162 of the coupling 152 and, at the same time, allows the balls to be removed from the recesses 176.

Once the head 114 is moved to the desired position and the balls 180 are received in corresponding recesses 176, the sleeve 182 is moved back to the locked position, such as by the spring 186, causing the ridge 184 of the sleeve to contact the balls 180 and secure them in the respective openings 162 and the recesses 176 to prevent rotation of the head. Referring to FIGS. 9 and 9A, an upper surface 184A of the ridge 184 is beveled toward the upper portion 182B of the sleeve 182 to gradually force the balls 180 into the respective recesses 176 as the sleeve is forced upward. As shown best in FIG. 9, when the balls 180 are received in the respective recesses 176, an outer portion of each ball extends radially outward from the opening 162 of the coupling 152. An annular stop member 185 (FIGS. 9 and 9A) projects radially inward from the ridge 184 of the sleeve 182 and contacts the outer portions of the balls 180 to maintain the ridge over the ball and to prevent the spring 186 from sliding the sleeve off the coupling 152.

Each of the recesses 176 of the head 114 correspond to a position in which the head can be rotated. In the illustrated embodiment, the head 114 can he rotated to four different positions. Other ways of locking and releasing the head 14 may be used within the scope of the present invention. When the head 14 of the tool 10 is rotated, the entire drive mechanism (i.e., the shaft and the air motor) is rotated. It is understood however that the drive mechanism may include a coupling which limits the amount of rotation in the drive mechanism (e.g., prevents the air motor from rotating when the head is being rotated).

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above without departing from the scope of the invention, it is intended that all matter contained in the above description and shown in the accompanying drawings shall be interpreted as illustrative and not in a limiting sense.

What is claimed is:

1. A ratchet tool comprising:
a housing having a longitudinal axis;
a head including a ratchet mechanism with an output member capable of powered rotation;
a motor disposed in the housing and operatively connected to the ratchet mechanism for rotating the output member; and
a coupling for attaching the head to the housing, the coupling being adapted to permit rotation of the head relative to the housing about the longitudinal axis of the housing.

2. A ratchet tool as set forth in claim 1 further comprising a locking mechanism capable of releasably locking the head in a selected angular position about the longitudinal axis of the housing.

3. A ratchet tool as set forth in claim 2 wherein the locking mechanism is adapted for quick release.

4. A ratchet tool as set forth in claim 3 wherein the locking mechanism is slidable generally along the longitudinal axis of the housing between a locked position in which the head is held against rotation relative to the housing, and a release position in which the head may rotate relative to the housing.

5. A ratchet tool as set forth in claim 4 wherein the locking mechanism is resiliently biased toward the locked position.

6. A ratchet tool as set forth in claim 4 wherein the locking mechanism comprises a catch engageable with the head of the tool in the locked position to lock the head relative to the housing in the selected angular position

7. A ratchet tool as set forth in claim 6 wherein the locking mechanism further comprises a locking member movable between the locked position, in which the member retains the catch in engagement with both the head, and an unlocked position, in which the member allows the catch to disengage with the head of the tool.

8. A ratchet tool as set forth in claim 7 wherein the head comprises a recess for receiving the catch and the coupling comprises an opening for receiving the catch.

9. A ratchet tool as set forth in claim 8 wherein the catch comprises a ball loosely received in the opening of the coupling.

10. A ratchet tool as set forth in claim 9 wherein the locking member comprises a sleeve surrounding at least a portion of the coupling and being longitudinally moveable with respect to the housing between the locked position and the unlocked position.

11. A ratchet tool as set forth in claim 10 wherein the sleeve comprises an internal retainer for retaining the ball in engagement with the recess of the housing in the locked position.

12. A ratchet tool as set forth in claim 11 wherein the locking mechanism further comprises a spring for biasing the sleeve in the locked position.

13. A ratchet tool as set forth in claim 11 wherein the sleeve is moveable toward the head of the tool to its unlocked position and is moveable toward the housing of the tool to its locked position.

14. A ratchet tool as set forth in claim 11 wherein the sleeve is moveable toward the housing of the tool to its unlocked position and is moveable toward the head of the tool to its locked position.

15. A ratchet tool as set forth in claim 1, wherein the tool is a pneumatic ratchet wrench, and the motor comprises an air motor, the wrench further comprising a power transmission extending from the air motor through the coupling to the ratchet mechanism.

16. A ratchet tool as set forth in claim 8 wherein the head comprises at least four recesses equidistantly spaced along a circumference of the head and arranged for engaging the catch.

17. A pneumatic ratchet tool comprising:
a housing having a longitudinal axis;
a head including a ratchet mechanism with an output member capable of powered rotation;
an air motor disposed in the housing and operatively connected to the ratchet mechanism for rotating the output member;
an air inlet for being coupled with a source of pressurized air for powering the air motor; and
a coupling for attaching the head to the housing, the coupling being adapted to permit rotation of the head relative to the housing about the longitudinal axis of the housing.

18. A pneumatic ratchet tool as set forth in claim 17 further comprising a locking mechanism capable of releasably locking the head in a selected angular position about the longitudinal axis of the housing.

19. A pneumatic ratchet tool as set forth in claim 18 wherein the locking mechanism is adapted for quick release.

20. A pneumatic ratchet tool as set forth in claim 19 wherein the locking mechanism is slidable generally along the longitudinal axis of the housing between a locked position in which the head is held against rotation relative to the housing, and a release position in which the head may rotate relative to the housing.
